(19) United States
(12) Patent Application Publication
(10) Pub. No.: US 2024/0152324 A1
(43) Pub. Date: May 9, 2024

(54) COMPUTATION CIRCUIT CAPABLE OF REDUCING QUANTIZATION ERROR

(71) Applicants: SK hynix Inc., Icheon (KR); POSTECH ACADEMY-INDUSTRY FOUNDATION, Pohand (KR)

(72) Inventors: Sein PARK, Daegu (KR); Eunhyeok Park, Pohang (KR)

(21) Appl. No.: 18/297,570

(22) Filed: Apr. 7, 2023

(30) Foreign Application Priority Data
Nov. 7, 2022 (KR) 10-2022-0147424

(51) Int. Cl. G06F 7/50

(52) U.S. Cl. CPC G06F 7/50

(57) ABSTRACT

A computation circuit includes a plurality of first operation circuits; a plurality of quantization circuits configured to quantize outputs of the plurality of first operation circuits, respectively; a plurality of second operation circuits configured to perform operations on outputs of the plurality of quantization circuits, respectively; and an adder circuit configured to perform element wise addition operation on outputs of the plurality of second operation circuits.

### CROSS-REFERENCE TO RELATED APPLICATION

The present application claims priority under 35 U.S.C. § 119(a) to Korean Patent Application No. 10-2022-0147424, filed on Nov. 7, 2022, which is incorporated herein by reference in its entirety.

### BACKGROUND

### 1. Technical Field

Various embodiments generally relate to a computation circuit capable of reducing quantization error.

### 2. Related Art

FIG. 1 is a block diagram showing a conventional computation circuit 10.

A conventional computation circuit includes a plurality of first convolution circuits 1-1, 1-2, and 1-3, a concatenation circuit 2, a quantization circuit 3 and a conventional second convolution circuit 4.

Each of the plurality of first convolution circuits 1-1, 1-2, and 1-3 performs a convolution operation.

The plurality of first convolution circuits 1-1, 1-2, and 1-3 may be located in different layers of a neural network including a plurality of layers.

The concatenation circuit 2 concatenates a plurality of calculation results output from a plurality of first convolution circuits 1-1, 1-2, and 1-3.

The quantization circuit 3 performs a quantization operation on the output of the concatenation circuit 2, and the conventional second convolution circuit 4 performs a convolution operation on the operation result output from the quantization circuit 3.

Outputs of the plurality of first convolution circuits 1-1, 1-2, and 1-3 correspond to calculation results performed through different paths. Due to the difference in these calculation paths, the calculation results may have different distributions and accordingly the output of the concatenation circuit 2 has a wide distribution.

The quantization circuit 3 performs the quantization operation on the output of the concatenation circuit 2 having a wide distribution without considering the difference in calculation paths, and accordingly, quantization error increases greatly in the conventional computation circuit 10.

### SUMMARY

In accordance with an embodiment of the present disclosure, a computation circuit may include a plurality of first operation circuits; a plurality of quantization circuits configured to quantize outputs of the plurality of first operation circuits, respectively; a plurality of second operation circuits configured to perform operations on outputs of the plurality of quantization circuits, respectively; and an adder circuit configured to perform element wise addition operation on outputs of the plurality of second operation circuits.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate various embodiments, and explain various principles and advantages of those embodiments.

FIG. 1 illustrates a conventional computation circuit.

FIG. 2 illustrates a computation circuit according to an embodiment of the present disclosure.

### DETAILED DESCRIPTION

The following detailed description references the accompanying figures in describing illustrative embodiments consistent with this disclosure. The embodiments are provided for illustrative purposes and are not exhaustive. Additional embodiments not explicitly illustrated or described are possible. Further, modifications can be made to presented embodiments within the scope of teachings of the present disclosure. The detailed description is not meant to limit this disclosure. Rather, the scope of the present disclosure is defined in accordance with claims and equivalents thereof. Also, throughout the specification, reference to “an embodiment” or the like is not necessarily to only one embodiment, and different references to any such phrase are not necessarily to the same embodiment(s).

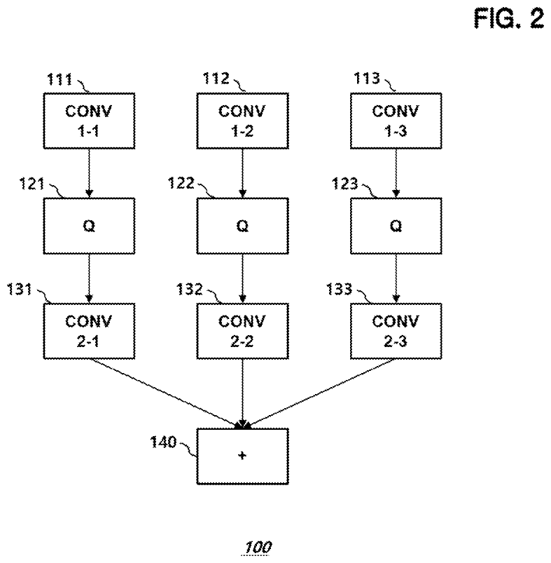

FIG. 2 is a block diagram showing a computation circuit 100 according to an embodiment of the present disclosure.

The computation circuit 100 is capable of reducing quantization errors while having an equivalent relationship with the conventional computation circuit 1.

The computation circuit 100 includes a plurality of first operation circuits 111, 112, and 113, a plurality of quantization circuits 121, 122, and 123, a plurality of second operation circuits 131, 132, and 133, and an adder circuit 140.

In this embodiment, it is assumed that the plurality of first operation circuits 111, 112, and 113 and the plurality of second operation circuits 131, 132, and 133 perform convolutional operation, but types of operation thereof may be changed according to embodiments.

For example, each of the plurality of first operation circuits 111, 112, and 113 may perform various neural network operations such as a bottleneck operation, a max-pooling operation, a matrix multiplication operation, or a combination thereof.

Moreover, each of the plurality of second operation circuits 131, 132, and 133 perform a linear operation such as a convolution operation, a matrix multiplication, or the like.

Hereinafter, a first operation circuit may be referred to as a first convolution circuit, and a second operation circuit may be referred to as a second convolution circuit.

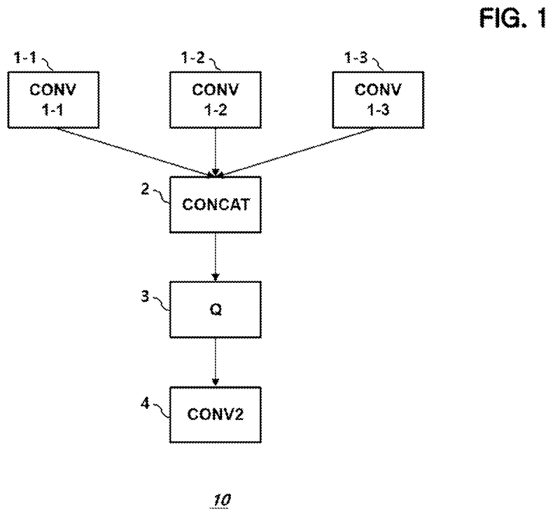

The plurality of first convolution circuits 111, 112, and 113 correspond to the plurality of first convolution circuits 1-1, 1-2, and 1-3 in FIG. 1.

In an illustrative embodiment, each of the plurality of first operation circuits 111, 112, and 113 performs an operation corresponding to any one layer among a plurality of layers included in a neural network.

The present embodiment is different from the prior art in that a quantization operation is separately performed for each operation path.

That is, the first, second, and third quantization circuits 121, 122, and 123 respectively quantize the operation results of the first convolution circuits 111, 112, and 113.

In addition, the second convolution circuits 131, 132, and 133, respectively perform convolution operations on the outputs of the first, second, and third quantization circuits 121, 122, and 123.

Even when the first to third quantization circuits 121, 122, and 123 perform operations in the same way as the conventional quantization circuit 3, quantization errors may be reduced because the quantization operations are respectively performed on data having a relatively limited range of distribution compared to the concatenated data quantized by the conventional quantization circuit 3.

In the conventional computation circuit 10, the concatenation circuit 2 concatenates channels of the plurality of first convolution circuits 111, 112, and 113.

That is, when numbers of channels of data output from the first convolution circuits 111, 112, and 113 are designated by N1, N2, and N3, respectively, a number of channels of data output from the concatenation circuit 2 corresponds to N, which corresponds to a sum of N1, N2, and N3.

Accordingly, the conventional second convolution circuit 4 performs a convolution operation using a kernel to process N input channels. Hereinafter, the input channels of the conventional second convolution circuit 4 are designated as input channel #1 through input channel #N.

In order to make the calculation result be equivalent, in the embodiment, kernels of the plurality of second convolution circuits 131, 132, and 133 use N1, N2, and N3 input channels, respectively, among input channels used by a kernel of the conventional second convolution circuit 4.

For example, the kernel used in the second convolution circuit 131 uses input channel #1 to input channel #N1 among input channels used in the kernel of the conventional second convolution circuit 4, the kernel used in the second convolution circuit 132 uses input channel #(N1+1) to input channel #(N1+N2) among input channels used in the kernel of the conventional second convolution circuit 4, and the kernel used in the second convolution circuit 133 uses input channel #(N1+N2+1) to input channel #N among input channels used in the kernel of the conventional second convolution circuit 4.

Since the plurality of second convolution circuits 131, 132, and 133 use the same kernel as the conventional second convolution circuit 4, the number of output channels of each of the plurality of second convolution circuits 131, 132, and 133 is the same as the number of output channels of the conventional second convolution circuit 4.

The adder circuit 140 performs an element wise addition operation on the respective output channels of the plurality of second convolution circuits 131, 132, and 133. In an embodiment, the adder circuit 140 adds the output channels of the plurality of second convolution circuits 131, 132, and 133 corresponding to the same input channels together.

Accordingly, the output of the adder circuit 140 becomes equivalent to the output of the conventional second convolution circuit 4.

The convolution operation and the element wise addition operation themselves are the same as the conventional art, and thus a detailed description thereof will be omitted.

In this embodiment, overhead may occur because the plurality of quantization circuits 121, 122, and 123 and second operation circuits 131, 132, and 133 are included, but unlike the prior art, the overall increase in cost is limited in that a concatenation circuit is not included while performance is improved by reducing quantization error.

Table 1 is an experimental result showing the effect of the present embodiment

TABLE 1

| | Prior Art | The Present Embodiment |
|---|---|---|
| W4A4 | 0.824 | 0.833 |
| W3A3 | 0.761 | 0.772 |

The neural network used in Table 1 is a You Only Look Once v5 small (YOLOv5s) neural network, and each value represent the mean Average Precision (mAP) index. The higher the mAP index, the better the performance. Table 1 shows that performance is improved by this embodiment.

In Table 1, W4A4 indicates that the number of bits of a weight of the kernel used in the convolution circuit is 4 and the number of bits of input data is 4. Likewise, W3A3 indicates that the number of bits of a weight of the kernel is 3 and the number of bits of the input data is 3.

Although various embodiments have been illustrated and described, various changes and modifications may be made to the described embodiments without departing from the spirit and scope of the invention as defined by the following claims.

What is claimed is:

1. A computation circuit comprising:
a plurality of first operation circuits;
a plurality of quantization circuits configured to quantize outputs of the plurality of first operation circuits, respectively;
a plurality of second operation circuits configured to perform operations on outputs of the plurality of quantization circuits, respectively; and
an adder circuit configured to perform element wise addition operation on outputs of the plurality of second operation circuits.

2. The computation circuit of claim 1, wherein each the plurality of first operation circuits performs a convolution operation, a bottleneck operation, a max pooling operation, or a matrix multiplication operation.

3. The computation circuit of claim 1, wherein each the plurality of second operation circuits performs a linear operation.

4. The computation circuit of claim 3, wherein the linear operation is a convolution operation or a matrix multiplication operation.

5. The computation circuit of claim 4, wherein respective kernels of the linear operations performed by the plurality of second operation circuits are the same.

6. The computation circuit of claim 3, wherein each the plurality of first operation circuits corresponds to a layer in a neural network including a plurality of layers.
